(19) United States
(12) Patent Application Publication
(10) Pub. No.: US 2026/0288045 A1
(43) Pub. Date: Sep. 24, 2026

(54) TRANSPORTATION DEVICE AND IMAGE FORMING APPARATUS

(71) Applicant: FUJIFILM Business Innovation Corp., Tokyo (JP)

(72) Inventors: Toshio KONDO, Kanagawa (JP); Ryuga OISHI, Kanagawa (JP); Hiroyuki MOMIYAMA, Kanagawa (JP); Toshitaka TANAKA, Kanagawa (JP)

(73) Assignee: FUJIFILM Business Innovation Corp., Tokyo (JP)

(21) Appl. No.: 19/298,212

(22) Filed: Aug. 13, 2025

(30) Foreign Application Priority Data
Mar. 21, 2025 (JP) 2025-047486

(51) Int. Cl. G03G 15/00; G03G 15/01

(52) U.S. Cl. CPC G03G 15/6558; G03G 15/0189; G03G 15/6502; G03G 15/70; G03G 2215/00371; G03G 2215/00413

(57) ABSTRACT

A transportation device includes a transportation member that transports a medium in a transportation direction, a reciprocating mechanism that reciprocates in the transportation direction and that moves at a speed lower than a transportation speed of the medium transported by the transportation member in a case where the reciprocating mechanism moves to a downstream side, an abutting member that is supported by the reciprocating mechanism and that switches between an abutment position at which the medium abuts against the abutting member on a transportation path of the medium and a withdrawal position to which the abutting member withdraws from the transportation path after the abutting member passes through a predetermined first position, a restricting member that restricts the medium, of which a leading end abuts against the abutting member, from being separated from the transportation path, and a switching unit that causes the abutting member to switch to the withdrawal position in a case where the medium is jammed on the transportation path.

### CROSS-REFERENCE TO RELATED APPLICATIONS

This application is based on and claims priority under 35 USC 119 from Japanese Patent Application No. 2025-047486 filed Mar. 21, 2025.

### BACKGROUND

### (i) Technical Field

The present disclosure relates to a transportation device and an image forming apparatus.

### (ii) Related Art

A paper sheet transportation device described in JP2012-224437A includes an abutting portion against which a leading end of a paper sheet abuts in a state of moving toward a downstream side in a paper sheet transportation direction and that corrects oblique motion of the paper sheet and an adjustment portion that adjusts, while moving toward the downstream side in the paper sheet transportation direction, a loop formed by the paper sheet abutting against the abutting portion.

### SUMMARY

Aspects of non-limiting embodiments of the present disclosure relate to a transportation device in which a medium can be easily extracted in comparison with a configuration in which a user causes an abutting member to withdraw from a transportation path in a case where the medium is jammed on the transportation path.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a transportation device including a transportation member that transports a medium in a transportation direction, a reciprocating mechanism that reciprocates in the transportation direction and that moves at a speed lower than a transportation speed of the medium transported by the transportation member in a case where the reciprocating mechanism moves to a downstream side, an abutting member that is supported by the reciprocating mechanism and that switches between an abutment position at which the medium abuts against the abutting member on a transportation path of the medium and a withdrawal position to which the abutting member withdraws from the transportation path after the abutting member passes through a predetermined first position, a restricting member that restricts the medium, of which a leading end abuts against the abutting member, from being separated from the transportation path, and a switching unit that causes the abutting member to switch to the withdrawal position in a case where the medium is jammed on the transportation path.

### BRIEF DESCRIPTION OF THE DRAWINGS

Exemplary embodiment(s) of the present invention will be described in detail based on the following figures, wherein:

FIG. 1 is a front view showing an image forming apparatus according to an exemplary embodiment of the present disclosure;

FIG. 2 is a block diagram of a controller, which shows a hardware configuration of the image forming apparatus according to the exemplary embodiment of the present disclosure;

FIG. 3 is a front view showing of a correction mechanism according to the exemplary embodiment of the present disclosure;

FIG. 4 is a front view showing a state where gates according to the exemplary embodiment of the present disclosure are at an abutment position during normal operation;

FIG. 5 is a front view showing a state where the gates according to the exemplary embodiment of the present disclosure are at a withdrawal position during normal operation;

FIG. 6 is a flowchart showing the way in which a controller according to a first exemplary embodiment causes gates to switch between positions;

FIG. 7 is a front view showing a state where the gates are at an abutment position in a case where a recording medium is jammed in a transportation device according to the first exemplary embodiment;

FIG. 8 is a front view showing a state where the gates move to a withdrawal position in a case where a recording medium is jammed in the transportation device according to the first exemplary embodiment;

FIG. 9 is a front view showing a transportation device according to a second exemplary embodiment;

FIG. 10 is a front view showing a state where the gates are moved in a forward movement direction from a state as shown in FIG. 9 in the transportation device according to the second exemplary embodiment;

FIG. 11 is a front view showing a state where a first stopper holds the gates in a case where a motor is in a demagnetization state in the transportation device according to the second exemplary embodiment;

FIG. 12 is a front view showing a transportation device according to a third exemplary embodiment;

FIG. 13 is a front view showing a state where a second stopper holds gates in the transportation device according to the third exemplary embodiment;

FIGS. 14A and 14B are respectively a lower-side perspective view and a cross-sectional view regarding the second stopper in the transportation device according to the third exemplary embodiment, the cross-sectional view being a sectional view taken along line S1-S1 in FIG. 13;

FIGS. 15A and 15B are respectively a plan view and a front view of a transportation device according to a fourth exemplary embodiment;

FIGS. 16A and 16B are respectively a plan view and a front view of a state where gates in the transportation device according to the fourth exemplary embodiment move to a withdrawal position;

FIG. 17 is a front view showing how the inside of a housing is in a case where a cover is in a closed state in a transportation device according to a fifth exemplary embodiment;

FIG. 18 is a front view showing how the inside of the housing is in a case where an operation of opening the cover is performed and thus the state of the cover is changed from the closed state to an opened state in the transportation device according to the fifth exemplary embodiment; and

FIG. 19 is a front view showing a state where a switching unit causes the gates to switch from an abutment position to a withdrawal position in a case where the cover is in the opened state in the transportation device according to the fifth exemplary embodiment.

### DETAILED DESCRIPTION OF THE INVENTION

Hereinafter, an example of an exemplary embodiment of the technology of the present disclosure will be described with reference to the drawings. The identical reference numerals are given to the identical or equivalent components and parts in each drawing.

Note that an arrow UP represents an upward direction of an image forming apparatus (hereinafter, an apparatus). An arrow DN represents a downward direction of the apparatus, which is a direction opposite to the direction represented by the arrow UP. An arrow RH represents a rightward direction of the apparatus. An arrow LH represents a leftward direction of the apparatus, which is a direction opposite to the direction represented by the arrow RH. An arrow FT represents a frontward direction of the apparatus. An arrow RR represents a rearward direction of the apparatus, which is a direction opposite to the direction represented by the arrow FT. The arrow UP and the arrow DN, the arrow RH and the arrow LH, and the arrow FT and the arrow RR are orthogonal to each other.

In addition, an arrow FW represents a forward movement direction of a movement direction of a reciprocating mechanism of the image forming apparatus. An arrow BW represents a backward movement direction, which is a direction opposite to the direction represented by the arrow FW. The arrow FW and the arrow BW may not coincide with the arrow RH and the arrow LH.

### Overall Configuration of Image Forming Apparatus

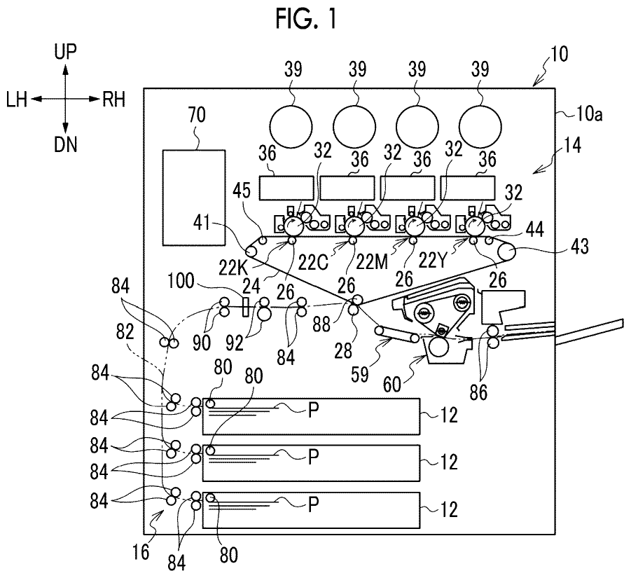

An image forming apparatus 10 forms an image on a recording medium P. The recording medium P is an example of a medium. As shown in FIG. 1, the image forming apparatus 10 includes a housing 10a in which each component is accommodated. Each of the components accommodated in the housing 10a can be pulled out forward with respect to the housing 10a. In the housing 10a, accommodation portions 12, an image forming unit 14, a transportation unit 16, a fixing device 60, and a controller 70 are provided.

### Accommodation Portions

A plurality of accommodation portions 12 are disposed in a lower portion of the image forming apparatus 10 and accommodate the sheet-shaped recording mediums P. In the present exemplary embodiment, three accommodation portions 12 are disposed in the lower portion of the image forming apparatus 10.

### Image Forming Unit

The image forming unit 14 forms an image on the recording medium P. The image forming unit 14 is an example of a forming unit. The image forming unit 14 includes image formation units 22Y, 22M, 22C, and 22K (hereinafter, “22Y to 22K”), an intermediate transfer belt 24, a primary transfer roll 26, and a secondary transfer roll 28.

The Image Formation Units 22y to 22k Form Yellow (y), Magenta (m), Cyan (c), and black (K) toner images, respectively.

Note that in the following description, in a case where yellow, magenta, cyan, and black are not to be particularly distinguished from each other, Y, M, C, and K at ends of reference numerals will be omitted.

The image formation units 22 of the respective colors are disposed above the intermediate transfer belt 24 and are arranged in a width direction. Each of the image formation units 22 performs a step of charging a photoreceptor 32, an exposure step, a development step, and a step of performing transfer to the intermediate transfer belt 24 which will be described later.

The toner images formed by the image formation units 22Y to 22K are transferred to the intermediate transfer belt 24. The intermediate transfer belt 24 is formed in a triangular shape such that a vertex thereof is on a lower side. Winding rolls 41, 43, 44, 45, and 88 around which the intermediate transfer belt 24 is wound are provided on an inner peripheral side of the intermediate transfer belt 24. For example, the intermediate transfer belt 24 circulates (rotates) in one direction (for example, a counterclockwise direction in FIG. 1) in a state of being in contact with the photoreceptors 32 by being rotationally driven by the winding roll 43.

The primary transfer rolls 26 transfer the toner images formed by the image formation units 22 to the intermediate transfer belt 24. The primary transfer rolls 26 of the respective colors face the photoreceptors 32 with the intermediate transfer belt 24 interposed therebetween.

The secondary transfer roll 28 transfers the toner images, which are transferred to the intermediate transfer belt 24 by the primary transfer rolls 26, to the recording medium P from the intermediate transfer belt 24. The secondary transfer roll 28 faces the winding roll 88 with the intermediate transfer belt 24 interposed therebetween. A position between the secondary transfer roll 28 and the winding roll 88 is a second transfer position where the toner images transferred onto the intermediate transfer belt 24 are transferred onto the recording medium P.

### Transportation Unit

The transportation unit 16 transports the recording medium P from the accommodation portions 12 to the image forming unit 14. The transportation unit 16 includes feeding rolls 80, transportation rolls 84, a correction mechanism 100, and a belt transportation unit 59.

A plurality of the feeding rolls 80 are disposed and each feeding roll 80 feeds the recording medium P accommodated in each accommodation portions 12 along a transportation path 82. The transportation path 82 is an example of a transportation path.

The transportation rolls 84 transport the recording medium P fed by the feeding roll 80 to the second transfer position. A plurality of pairs of the transportation rolls 84 are disposed along the transportation path 82. The transportation rolls 84 include first transportation rolls 90 and second transportation rolls 92.

The first transportation rolls 90 transport the recording medium P in a transportation direction at a predetermined first speed. The first speed is an example of a transportation speed. The second transportation rolls 92 are disposed downstream of the first transportation rolls 90 in the transportation direction in a state of being separated from each other in a front-rear direction and receive the recording medium P from gates 200 which will be described later. The diameter of one of the second transportation rolls 92 that is disposed on a lower side in the transportation path 82 is larger than the diameter of the other of the second transportation rolls 92 that is disposed on an upper side in the transportation path 82. In the present exemplary embodiment, a plurality of pairs of the second transportation rolls 92 are disposed in a state of being separated from each other in the front-rear direction.

The correction mechanism 100 is disposed between the first transportation rolls 90 and the second transportation rolls 92. Details of the correction mechanism 100 will be described later.

The belt transportation unit 59 transports the recording medium P, to which the toner images are transferred by the secondary transfer roll 28, to a downstream side with respect to the second transfer position in the transportation direction of the recording medium P.

### Fixing Device

The fixing device 60 is disposed downstream of the belt transportation unit 59 in the transportation direction. The fixing device 60 fixes, onto the recording medium P, the toner images transferred to the recording medium P. The fixing device 60 is provided with discharge rolls 86. The discharge rolls 86 discharge, from the housing 10a, the recording medium P onto which the toner images are fixed.

### Controller

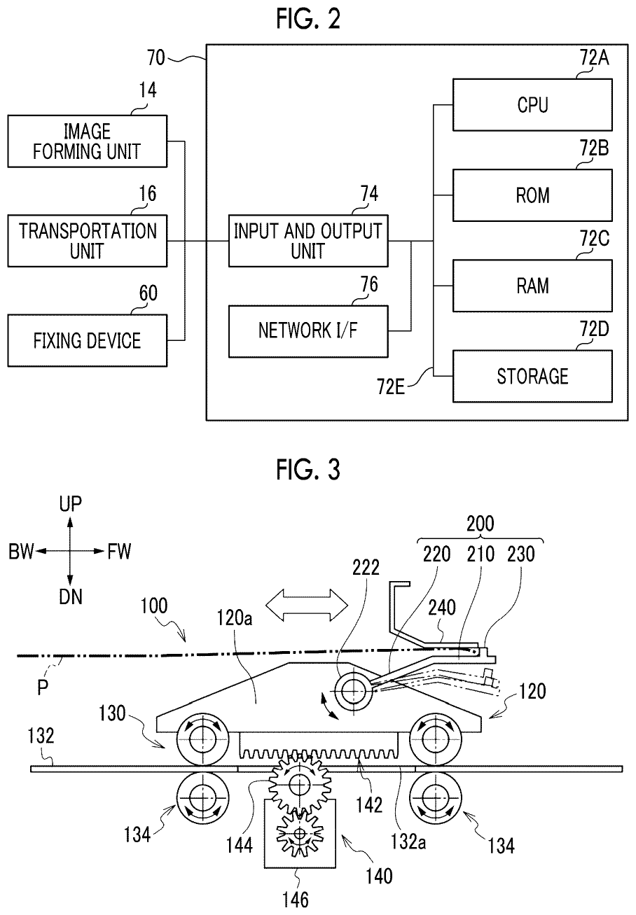

The controller 70 controls each component of the image forming apparatus 10. As shown in FIG. 2, the controller 70 includes each component of a central processing unit (CPU) 72A, a read only memory (ROM) 72B, a random access memory (RAM) 72C, a storage 72D, an input and output unit 74, and a network interface (network I/F) 76. These components are connected to be capable of communicating with each other via a bus 72E.

The CPU 72A is a central arithmetic processing unit and the CPU 72A executes various programs or controls each unit. That is, the CPU 72A reads out a program from the ROM 72B or the storage 72D and executes the program while using the RAM 72C as a work area. The CPU 72A controls each component and performs various operation processes in accordance with the program recorded in the ROM 72B or the storage 72D.

The ROM 72B stores various programs and various types of data. The RAM 72C temporarily stores a program or data as the work area. The storage 72D is composed of a hard disk drive (HDD) or a solid state drive (SSD) and stores various programs including an operating system and various types of data.

The input and output unit 74 receives signals between each of the components of the image forming apparatus 10 in order to exhibit the function of the image forming apparatus 10. Specifically, the input and output unit 74 is connected to the image forming unit 14, the transportation unit 16 including the correction mechanism 100 which will be described later, and the fixing device 60 and is connected to the CPU 72A and the like.

The network interface (network I/F) 76 is an interface used to communicate with other devices such as a database and a server (not shown), and for example, standards such as Ethernet (registered trademark), FDDI, or Wi-Fi (registered trademark) are used.

### Image Forming Operation

Next, an image forming operation of forming an image on the recording medium P in the image forming apparatus 10 according to the present exemplary embodiment will be described.

In the image forming apparatus 10, the recording medium P fed from the accommodation portion 12 by the feeding roll 80 is fed to the second transfer position by a plurality of the transportation rolls 84.

Meanwhile, in the image formation units 22 of the respective colors, toner images are formed on the photoreceptors 32 through the charging of the photoreceptors 32, exposure, and development.

Color toner images respectively formed by the image formation units 22 are superimposed on the intermediate transfer belt 24 at a first transfer position by the primary transfer rolls 26 of the respective colors, so that a color image is formed. Then, the color image formed on the intermediate transfer belt 24 is transferred onto the recording medium P by the secondary transfer roll 28.

The recording medium P onto which the toner images are transferred is transported to the fixing device 60 by the belt transportation unit 59, and the transferred toner images are fixed by the fixing device 60. The recording medium P onto which the toner images are fixed is discharged from the housing 10a by the discharge rolls 86.

### Configuration of Correction Mechanism

Next, the correction mechanism 100 will be described. The correction mechanism 100 corrects inclination of the recording medium P with respect to the transportation direction by causing a leading end of the recording medium P to abut against the gates 200 which will be described later. The correction mechanism 100 transports the recording medium P in the transportation direction at a second speed lower than the first speed. The correction mechanism 100 constitutes a transportation device together with the first transportation rolls 90. As shown in FIG. 3, the correction mechanism 100 includes a carriage 120, the gates 200, and a chute 240.

### Carriage

The carriage 120 is able to reciprocate in the transportation direction between the first transportation rolls 90 and the second transportation rolls 92. The carriage 120 is an example of a reciprocating mechanism. The carriage 120 moves at the second speed in the forward movement direction. In addition, movement in the forward movement direction is an example of movement toward a downstream side. The carriage 120 is provided with a guide mechanism 130 and a driving mechanism 140 with respect to a body 120a.

The guide mechanism 130 guides the body 120a such that the carriage 120 moves along the transportation direction. The guide mechanism 130 includes a support plate 132 and pairs of roll members 134.

The support plate 132 is a plate-shaped body that is supported by the housing 10a and that extends in the transportation direction. In the present exemplary embodiment, the support plate 132 extends in the transportation direction in an area in which the carriage 120 reciprocates. The support plate 132 supports the body 120a from below. A long hole 132a is formed in the support plate 132. The long hole 132a is a hole formed along the transportation direction.

The pairs of roll members 134 are supported to be rotatable with respect to the body 120a. One of paired roll members 134 is in contact with an upper surface of the support plate 132. In addition, the other of the paired roll members 134 is in contact with a lower surface of the support plate 132. Accordingly, the pairs of roll members 134 guide the carriage 120 that reciprocates. In the present exemplary embodiment, two pairs of roll members 134 are provided on an upstream side and a downstream side in a movement direction of the carriage 120.

The driving mechanism 140 is provided below the body 120a. The driving mechanism 140 reciprocates the body 120a in the transportation direction. The driving mechanism 140 includes a rack 142, a pinion 144, and a motor 146.

The rack 142 extends in the transportation direction. The rack 142 is supported by the body 120a in a state of facing a lower side.

The pinion 144 is supported to be rotatable with respect to the housing 10a. The pinion 144 is disposed below the rack 142 in a state where a part of the pinion 144 protrudes through the long hole 132a. The pinion 144 meshes with the rack 142.

The motor 146 is supported by the housing 10a. The motor 146 rotates the pinion 144 by means of an output gear. The motor 146 can be rotated forward and backward. In the present exemplary embodiment, the motor 146 drives the output gear so that the pinion 144 and the rack 142 are driven.

In a case where a sensor (not shown) that is disposed at a predetermined position on the transportation path 82 (for example, a position upstream of the first transportation rolls 90) detects a leading end of the recording medium P while the recording medium P is being transported, the motor 146 drives the output gear such that the body 120a moves at the second speed in the forward movement direction without a change in speed. In addition, in a case where a sensor (not shown) that is disposed upstream of the second transportation rolls 92 detects the leading end of the recording medium P while the recording medium P is being transported, the motor 146 drives the pinion 144 such that the body 120a moves at a predetermined speed in the backward movement direction (for example, at 75% of the first speed).

Accordingly, the carriage 120 reciprocates in the transportation direction.

### Gate

The gates 200 are formed as plate-shaped bodies on which the recording medium P can be placed. The gates 200 are supported with respect to the carriage 120 to be vertically swingable around a central axis of a shaft 222. Swinging is an example of rotation. The gates 200 can switch between an abutment position where the leading end of the recording medium P abuts against the gates 200 on the transportation path 82 and a withdrawal position to which the gates 200 are rotated with respect to the carriage 120 and withdraw from the transportation path 82 after passing through a predetermined position on the transportation path 82. The gates 200 correct inclination of the recording medium P with respect to the transportation direction at the abutment position. The gates 200 are an example of an abutting member.

In the present exemplary embodiment, a plurality of the gates 200 are disposed in a state of being separated from each other in a front-rear direction. In addition, in the present exemplary embodiment, the gates 200 can protrude or withdraw through an opening of a plate (not shown), which is supported by the housing 10a along the transportation path 82, by means of a major portion which will be described later. At the abutment position, the gates 200 partially protrude through the opening. Meanwhile, at the withdrawal position, the gates 200 are positioned below the plate. That is, the gates 200 withdrawn from the transportation path 82 may also mean the gates 200 being positioned below the plate.

Each of the gates 200 includes a base portion 210, a connection portion 220, and a protruding piece 230.

The base portion 210 is a plate-shaped portion extending in one direction. The base portion 210 guides, to the protruding piece 230, the recording medium P placed from above.

The connection portion 220 is a plate-shaped portion that extends obliquely toward the shaft 222 from the base portion 210 and connects the base portion 210 to the body 120a of the carriage 120 to be rotatable. Specifically, one end of the connection portion 220 is integrally connected to the shaft 222. In addition, the other end of the connection portion 220 is connected to the base portion 210.

The protruding piece 230 is a wall-shaped portion that extends in the front-rear direction and that is erected on the base portion 210. The protruding piece 230 is disposed at a position offset from an end portion of the base portion 210 that is on the downstream side in the transportation direction, the protruding piece 230 being positioned upstream of the end portion. The protruding piece 230 abuts against a leading end of the recording medium P at the abutment position. The protruding piece 230 includes a first surface and a second surface.

The first surface is a surface facing the upstream side in the transportation direction. The first surface comes into contact with the leading end of the recording medium P.

The second surface is formed on a side opposite to the first surface and is a surface facing the downstream side in the transportation direction. The second surface is disposed at a position offset from an end surface of the base portion 210 that is on the downstream side in the transportation direction, the second surface being positioned upstream of the end surface. as described above, each gate 200 is configured.

### Chute

The chute 240 is a plate material extending in the front-rear direction. The chute 240 restricts the recording medium P, of which the leading end abuts against the gate 200, from being separated from the transportation path 82. The chute 240 is an example of a restricting member.

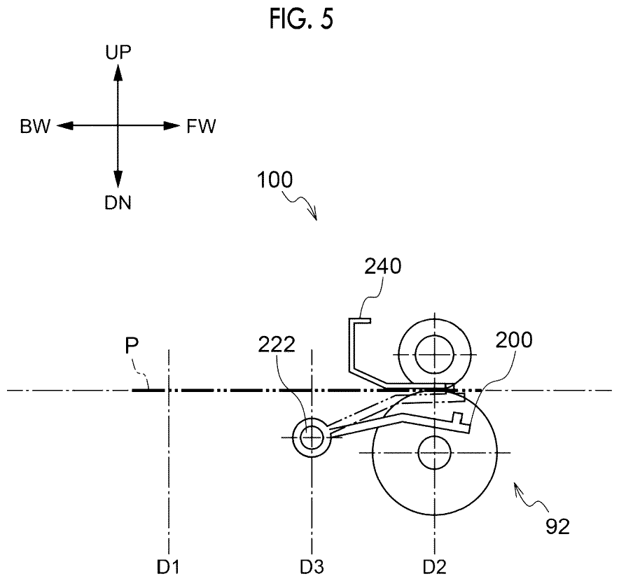

In the present exemplary embodiment, the chute 240 is formed in a comb-like shape extending in the front-rear direction. The chute 240 is disposed above the gates 200 with a comb tooth portion facing the downstream side in the transportation direction. The chute 240 restricts, by means of the comb tooth portion, the recording medium P from being separated from the transportation path 82. The chute 240 moves in a state of being supported by the carriage 120 via a bracket (not shown) as the carriage 120 reciprocates. The chute 240 is set such that the second transportation rolls 92 enter the comb teeth portion at the withdrawal position (refer to FIG. 5).

As described above, the correction mechanism 100 is configured.

### Correction Performed by Correction Mechanism

Next, inclination correction of the recording medium P with respect to the transportation direction, which is performed by the correction mechanism 100, will be described.

Note that in the following description, a position D1 refers to the position of the shaft 222 reciprocating in the transportation direction together with the carriage 120 and the gate 200. Specifically, the position D1 is an abutment position and refers to a position where the shaft 222 is when the recording medium P abuts against the gates 200. A position D2 refers to the position of the second transportation rolls 92. A position D3 is a position where the shaft 222 is after the gates 200 switch from the abutment position to the withdrawal position, and refers to a forward movement limit of the carriage 120 for the case of normal operation. The case of normal operation refers to the case of operation without the recording medium P being jammed at the transportation path 82. The position D3 is an example of a position where the shaft 222 is after the gates 200 pass through a predetermined first position.

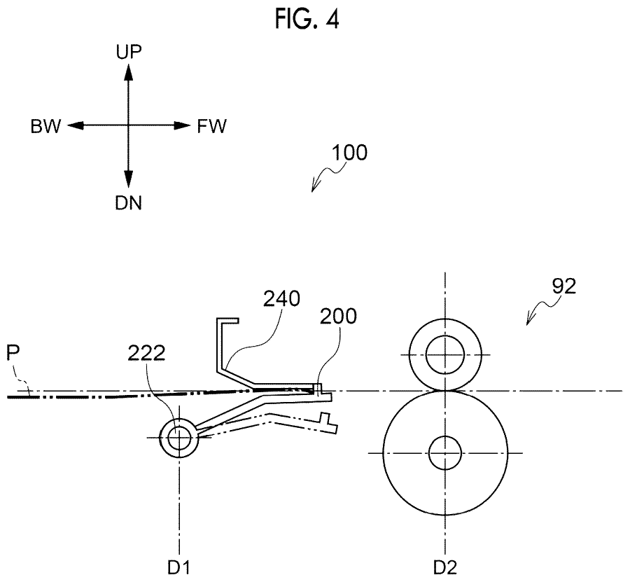

In the correction mechanism 100, in a case where a sensor (not shown) detects that the recording medium P is being transported by the first transportation rolls 90 (refer to FIG. 1), the motor 146 is driven so that the carriage 120 starts to move at the second speed in the forward movement direction. As the carriage 120 moves at the second speed, the gate 200 also moves at the second speed in the forward movement direction. As shown in FIG. 4, a leading end of the recording medium P transported at the first speed abuts against the gates 200 that move at the second speed without a change in speed and that are at the abutment position. The recording medium P is continuously transported with the leading end abutting against the gates 200 and the recording medium P being restricted from being separated from the transportation path 82 by the chute 240. Accordingly, the leading end of the recording medium P is aligned along the front-rear direction, and inclination of the recording medium P with respect to the transportation direction is corrected. As shown in FIG. 5, the recording medium P of which the inclination with respect to the transportation direction is corrected is delivered to the second transportation rolls 92 with the gates 200 switching from the abutment position to the withdrawal position.

Meanwhile, in the correction mechanism 100, in a case where a sensor (not shown) detects that the recording medium P is being transported by the second transportation rolls 92, the motor 146 is driven so that the carriage 120 starts to move in the backward movement direction. While the carriage 120 is moving in the backward movement direction, the gates 200 switch from the withdrawal position to the abutment position. Then, the correction mechanism 100 waits for transportation of another recording medium P. A position at which the correction mechanism 100 waits for transportation of the recording medium P will be referred to as a waiting position. The waiting position (not shown) is a position that is downstream of the position D1 in the backward movement direction, that is, a position upstream of the position D1 in the transportation direction.

### Major Part of First Exemplary Embodiment

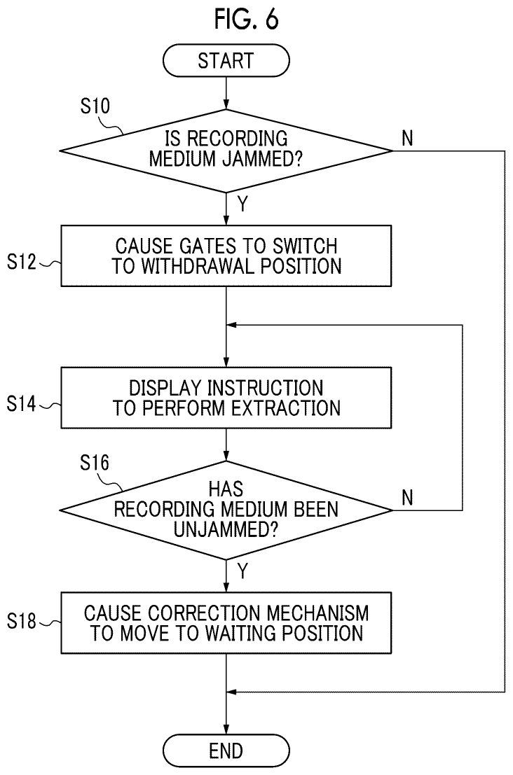

Next, a major part of a first exemplary embodiment will be described with reference to FIGS. 6 to 8. Note that in the following description, the second transportation rolls 92 and the gates 200 of the correction mechanism 100, and operations related to the second transportation rolls 92 and the gates 200 will be described.

In the present exemplary embodiment, in a case where a sensor (not shown) detects that the recording medium P is jammed on the transportation path 82, the controller 70 drives a motor (not shown) to cause the gates 200 to switch from the abutment position to the withdrawal position. The controller 70 is an example of a switching unit. Note that in the present exemplary embodiment, in a case where a user pulls out an internal component of the housing 10a from the housing 10a when the user extracts the recording medium P from the transportation path 82, the motor causes the gates 200 to be held at the withdrawal position.

### Flowchart

The control of the correction mechanism 100 including causing the gates 200 to switch between positions, which is performed by the controller 70, will be described with reference to FIG. 6.

In step S10, the CPU 72A of the controller 70 determines whether or not the recording medium P is jammed on the transportation path 82.

In a case where the result of the determination is “N” indicating false, the CPU 72A ends the flow.

However, in a case where the result of the determination is “Y” indicating true, the CPU 72A proceeds to step S12.

In step S12, the CPU 72A causes the gates 200 to switch to the withdrawal position. Then, the CPU 72A proceeds to step S14.

In step S14, the CPU 72A causes a display unit (not shown) to display, for a user of the image forming apparatus 10, an instruction to perform extraction. For example, the instruction includes an instruction to pull out an internal component of the housing 10a from the housing 10a. Then, the CPU 72A proceeds to step S16.

In step S16, the CPU 72A determines whether or not the recording medium P has been unjammed.

In a case where the result of the determination is “N”, the CPU 72A proceeds to step S14.

In a case where the result of the determination is “Y”, the CPU 72A proceeds to step S18.

In step S18, the CPU 72A causes the correction mechanism 100 to move to the waiting position. Then, the CPU 72A ends the flow.

The controller 70 of the present exemplary embodiment controls the correction mechanism 100 as described above.

Next, an example of the way in which the controller 70 causes the gates 200 to switch between positions will be described.

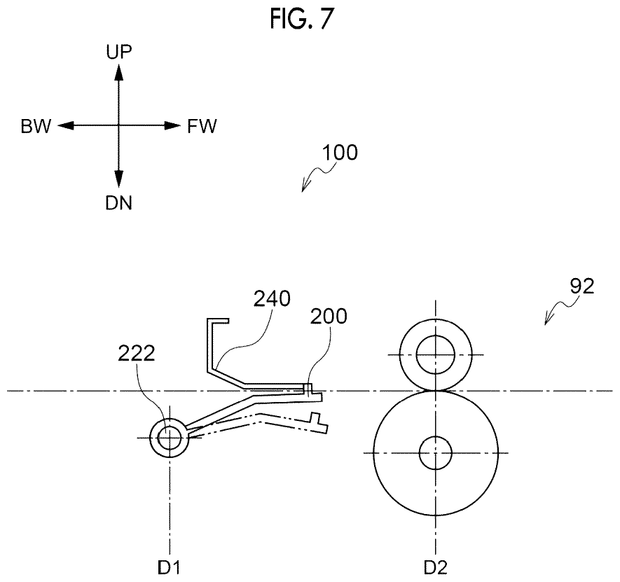

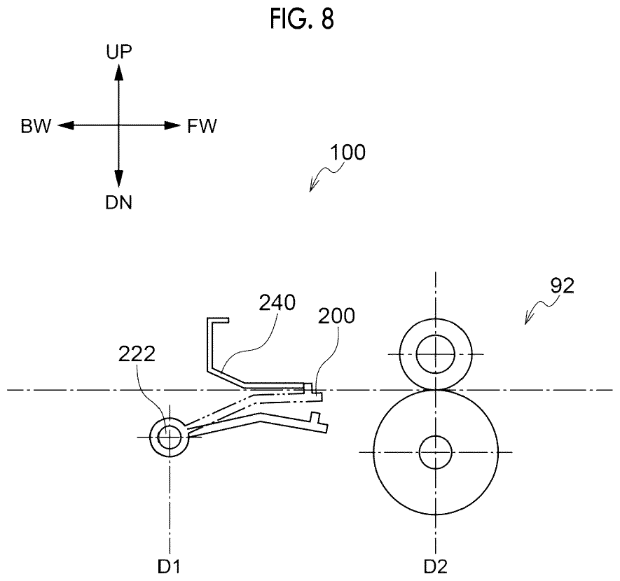

In a case where the recording medium P is jammed at the first position D1 as shown in FIG. 7, the controller 70 causes the gates 200 to switch from the abutment position to the withdrawal position at the first position D1 as shown in FIG. 8. That is, in the present exemplary embodiment, the gates 200 switch from the abutment position to the withdrawal position at a position where the recording medium P is jammed without movement of the carriage 120.

### Action and Effect of First Exemplary Embodiment

The action and effect of the first exemplary embodiment will be described.

The transportation device including the first transportation rolls 90 and the correction mechanism 100 according to the present exemplary embodiment includes the first transportation rolls 90 that transport the recording medium P in the transportation direction, the carriage 120 that reciprocates in the transportation direction and that moves at the second speed lower than the first speed, which is the transportation speed of the recording medium P transported by the first transportation rolls 90, in a case where the carriage 120 moves in the forward movement direction, the gates 200 that are supported by the carriage 120 and that switch between the abutment position at which the recording medium P abuts against the gates 200 on the transportation path 82 of the recording medium P and the withdrawal position to which the gates 200 withdraw from the transportation path 82 after the gates 200 pass through a predetermined position, the chute 240 that restricts the recording medium P, of which a leading end abuts against the gates 200, from being separated from the transportation path 82, and the controller 70 that causes the gates 200 to switch to the withdrawal position in a case where the recording medium P is jammed on the transportation path 82.

According to such a configuration, the recording medium P may be easily extracted in comparison with a configuration in which a user causes the gates 200 to withdraw from the transportation path 82 in a case where the recording medium P is jammed on the transportation path 82.

In addition, the image forming apparatus according to the present exemplary embodiment includes the transportation device including the first transportation rolls 90 and the correction mechanism 100 and the image forming unit 14 that forms an image on the recording medium P transported by the transportation device.

According to such a configuration, the image forming apparatus 10 may be provided in which the recording medium P is easily extracted in comparison with a configuration in which a user causes the gates 200 to withdraw from the transportation path 82 in a case where the recording medium P is jammed on the transportation path 82.

### Second Exemplary Embodiment

Next, a second exemplary embodiment will be described. In the second exemplary embodiment, some components and a movement area of the carriage 120 are different with respect to the major part of the first exemplary embodiment. The correction mechanism 100 of the second exemplary embodiment further includes an urging member (not shown), a motor (not shown), and a first stopper 260.

Note that in the following description, a position D4 refers to a position where the shaft 222 is in a case where the carriage 120 moves beyond the forward movement limit of the carriage 120 for the case of normal operation.

### Urging Member

One or a plurality of urging members are disposed in the front-rear direction. The urging member urges the gates 200 from the withdrawal position side to the abutment position side. For example, the urging member is a tension spring.

### Motor

The motor is supported by the housing 10a. The motor can drive the shaft 222 around the central axis via, for example, a belt. The motor drives the shaft 222 at a predetermined rotation angle in a direction predetermined by the controller 70.

In addition, the controller 70 causes the motor to switch between an excitation state and a demagnetization state. The excitation state refers to a state where the motor is energized. The demagnetization state refers to a state where energization of the motor is stopped. In the present exemplary embodiment, in a case where the motor is in the excitation state, the motor moves the gates 200 to the withdrawal position via the shaft 222 and the gates 200 are held at the withdrawal position. In addition, in the present exemplary embodiment, in a case where the motor is in the demagnetization state, an urging force of the urging member forcibly moves, to the abutment position side, the gates 200 that are at the withdrawal position. The demagnetization state is caused also in a case where an internal component of the housing 10a is pulled out from the housing 10a.

### First Stopper

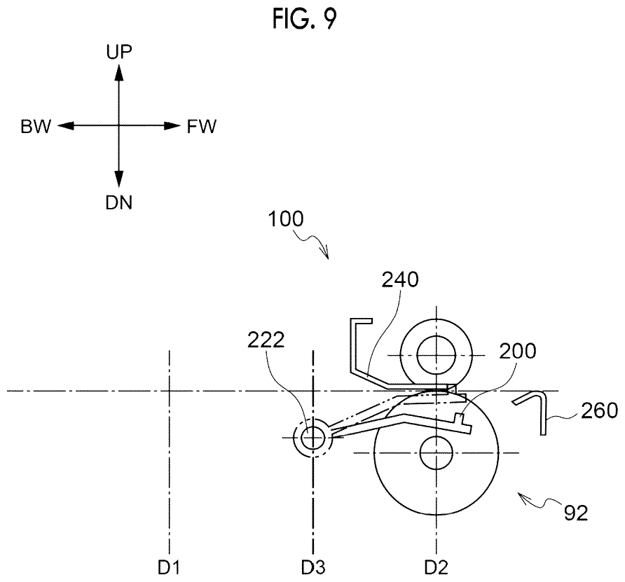

As shown in FIG. 9, the first stopper 260 is disposed downstream of the second transportation rolls 92 in the transportation direction. The first stopper 260 is a bent plate that is inclined from the downstream side to the upstream side in the transportation direction in a state of extending in the front-rear direction. The first stopper 260 is supported by the housing 10a. The first stopper 260 mechanically holds, at the withdrawal position, the gates 200 moved to the withdrawal position due to excitation of the motor.

In addition, the first stopper 260 is an example of a holding portion. The angle of inclination and the length of protrusion to the upstream side in the transportation direction of the first stopper 260 are set in accordance with the trajectory of end portions of the gates 200 returning from the withdrawal position side to the abutment position side.

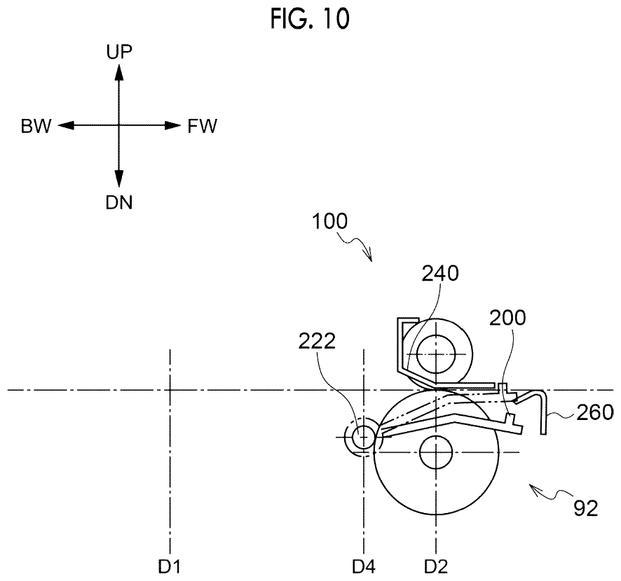

In addition, as shown in FIG. 10, the first stopper 260 is configured as a stopper that comes into contact with the gates 200 positioned at the withdrawal position in a state where the gates 200 are moved to the downstream side beyond the forward movement limit (the position D3) of the carriage 120 for the case of normal operation.

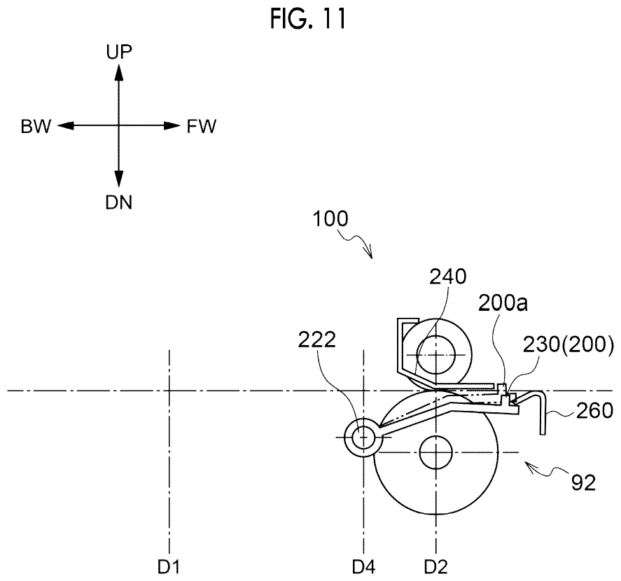

In addition, as shown in FIG. 11, in a case where the gates 200 rotate to the abutment position side via the shaft 222 with the motor entering the demagnetization state, the first stopper 260 holds the gates 200 at a position closer to the withdrawal position side than to the abutment position. Specifically, the first stopper 260 holds the second surfaces of the protruding pieces 230 of the gates 200 or end portions of the base portions 210 that are on the downstream side in the transportation direction.

Note that the gates 200 are held close to the withdrawal position side by the first stopper 260, in comparison with a gate 200a moved to the abutment position without provision of the first stopper 260.

As described above, the correction mechanism 100 of the second exemplary embodiment is configured.

### Action and Effect of Second Exemplary Embodiment

The action and effect of the second exemplary embodiment will be described.

The transportation device according to the present exemplary embodiment further includes the urging member that urges the gates 200 to the abutment position and the motor that moves the gates 200 to the withdrawal position and holds the gate 200 at the withdrawal position in an excitation state and the switching unit includes, in addition to the controller 70, the first stopper 260 that mechanically holds, at the withdrawal position, the gates 200 moved to the withdrawal position due to excitation of the motor.

According to the configuration, the gates 200 may be held at the withdrawal position even in a case where the motor enters the demagnetization state.

In the transportation device according to the present exemplary embodiment, the first stopper 260 is configured as a stopper that comes into contact with the gates 200 positioned at the withdrawal position in a state where the gates 200 are moved beyond the position D3 of the shaft 222, which corresponds to a movement limit of the carriage 120 for the case of normal operation.

According to such a configuration, the gates 200 are restrained from being held at the withdrawal position in the case of normal operation, in comparison with a case where a stopper is in a reciprocating movement area for the case of normal operation.

### Third Exemplary Embodiment

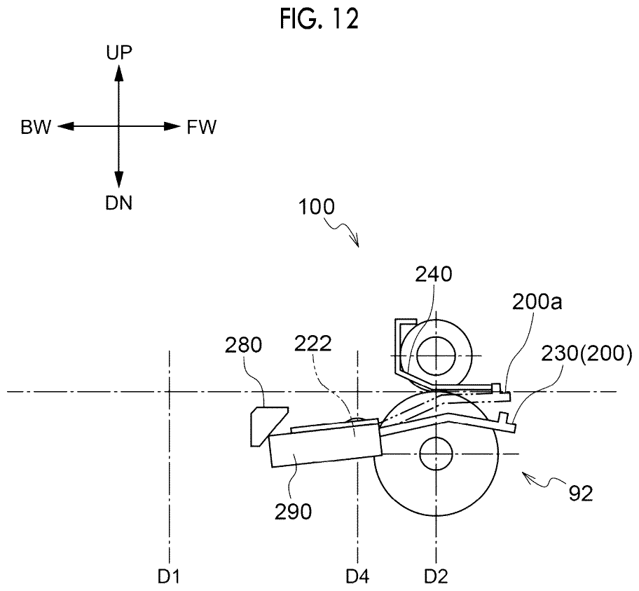

Next, a third exemplary embodiment will be described with reference to FIGS. 12 to 14B. In the third exemplary embodiment, the configuration of a holding portion is different with respect to the major part of the second exemplary embodiment. The correction mechanism 100 of the third exemplary embodiment includes a second stopper 280 instead of the first stopper 260.

### Second Stopper

The second stopper 280 is disposed upstream of the second transportation rolls 92 in the transportation direction and is disposed at a front end portion of the shaft 222. In other words, the second stopper is disposed outside the sheet passage area as seen in a plan view. The sheet passage area is an area in which the recording medium P having the maximum size that can be processed by the image forming apparatus 10 passes through the transportation path 82. The second stopper 280 is supported by the carriage 120 (refer to FIG. 3) via a bracket (not shown). That is, the second stopper 280 reciprocates in the transportation direction together with the carriage 120.

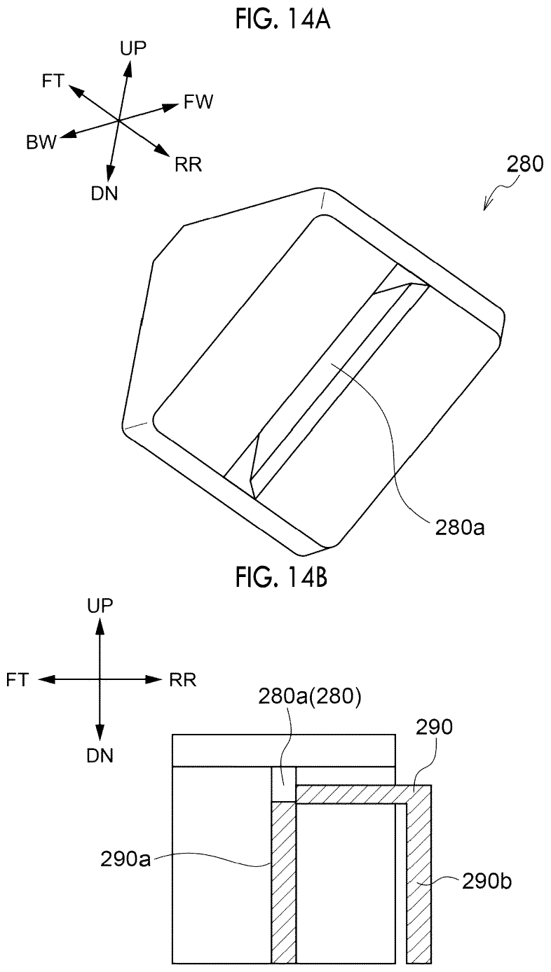

In addition, as shown in FIG. 14A, the second stopper 280 is a triangular columnar body of which the height direction is parallel to the front-rear direction. A slit 280a is formed in the second stopper 280.

The slit 280a extends in a reciprocating direction and a vertical direction and is formed at the center of an inclined surface portion in the height direction of the second stopper 280. The slit 280a is formed to have such a groove width that a first plate portion 290a of a bracket 290, which will be described later, can be clamped at the slit 280a. Being clamped is an example of being engaged. In addition, the second stopper 280 is an example of a holding portion.

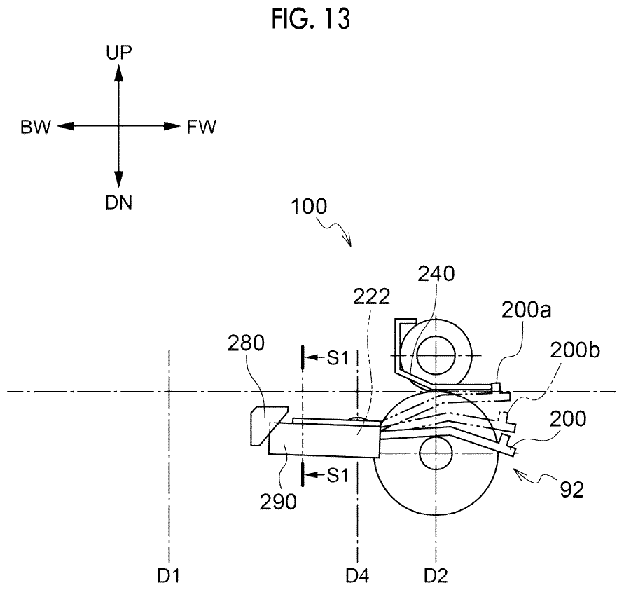

As shown in FIGS. 13 and 14B, the first plate portion 290a of the bracket 290 is clamped at the slit 280a. The second stopper 280 in which the slit 280a is formed is made of, for example, resin.

As shown in FIG. 14B, the bracket 290 is a bent plate material of which the cross section has an inverted U-like shape. As shown in FIGS. 12 and 13, the bracket 290 is supported by the gates 200. The bracket 290 is disposed outside the sheet passage area. The bracket 290 rotates integrally with the gates 200. The bracket 290 includes the first plate portion 290a and a second plate portion 290b.

The first plate portion 290a extends in one direction. The first plate portion 290a is clamped at the slit 280a of the second stopper 280. Specifically, a corner portion of the first plate portion 290a is clamped at the second stopper 280 in a state where the gates 200 are moved to the withdrawal position side beyond the movement limit for the case of normal operation.

The second plate portion 290b extends along a direction in which the first plate portion 290a extends. The second plate portion 290b is disposed between the front end portion of the shaft 222 in the front-rear direction and the first plate portion 290a. The second plate portion 290b is supported by the front end portion of the shaft 222. The length of the second plate portion 290b in a direction in which the second plate portion 290b extends is set to be smaller than the length of the first plate portion 290a in the direction in which the first plate portion 290a extends. Specifically, one end of the second plate portion 290b in the direction in which the second plate portion 290b extends is disposed at a position at which the one end does not interfere with the second stopper 280. In a state where the first plate portion 290a is clamped at the second stopper 280, the second plate portion 290b is disposed closer to the rear side than one end of the second stopper 280 in the front-rear direction is.

### Action and Effect of Third Exemplary Embodiment

### The Action and Effect of the Third Exemplary Embodiment Will Be Described.

In the transportation device according to the present exemplary embodiment, the second stopper 280 is configured as an engagement portion that is engaged with the first plate portion 290a of the bracket 290, which integrally rotates with the gates 200, in a state where the gates 200 are moved to the withdrawal position side beyond the movement limit (the position of a gate 200b in FIG. 13) for the case of normal operation.

According to the configuration, the gates 200 are restrained from being held at the withdrawal position in the case of normal operation in comparison with a case where the second stopper 280 is in a withdrawal-position-side movement area for the case of normal operation.

### Fourth Exemplary Embodiment

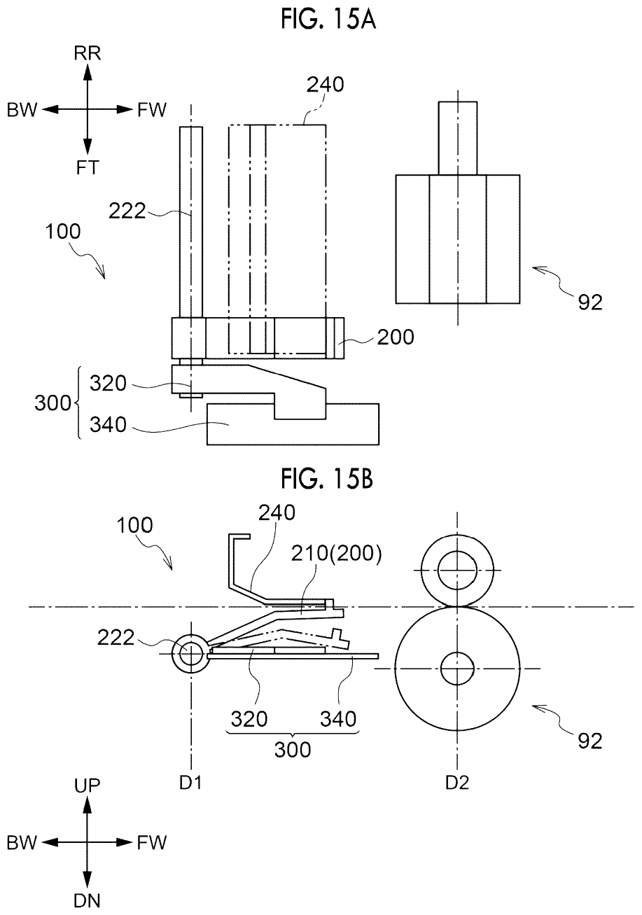

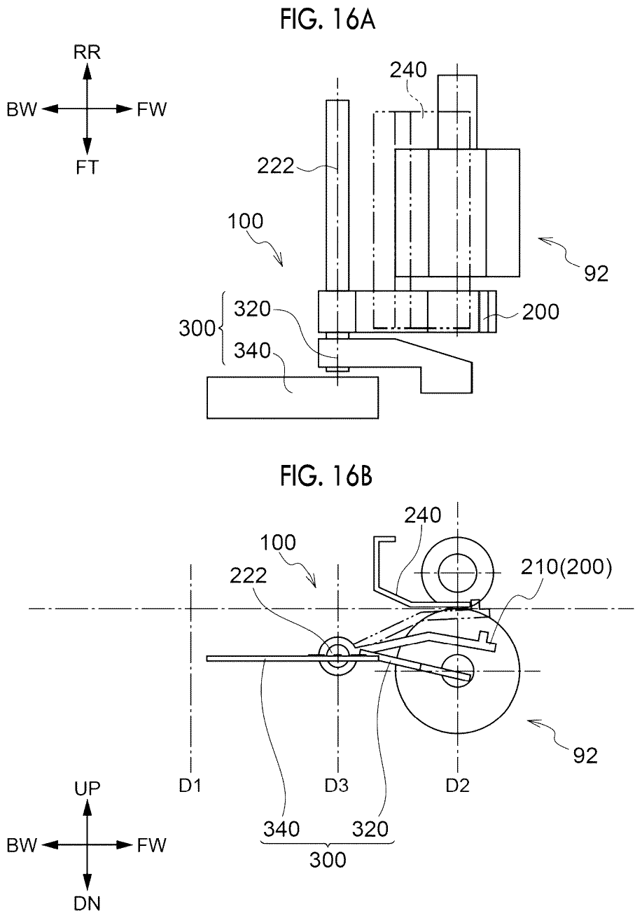

Next, a fourth exemplary embodiment will be described with reference to FIGS. 15A to 16B. In the fourth exemplary embodiment, the configuration of the correction mechanism 100 is different with respect to the major part of the first exemplary embodiment. The correction mechanism 100 of the fourth exemplary embodiment includes a fall prevention member 300. Note that the gates 200 according to the present exemplary embodiment are configured to switch to the withdrawal position as the carriage 120 moves to the downstream side.

Fall Prevention Member

As shown in FIGS. 15A and 15B, the fall prevention member 300 prevents the gates 200 from being rotated to the withdrawal position side by the transported recording medium P until the gates 200 pass through a predetermined position. The fall prevention member 300 is an example of a switching unit. The fall prevention member 300 includes a first member 320 and a second member 340.

The first member 320 is formed in a thin plate-like shape and is supported at an end portion on the upstream side in the transportation direction to be non-rotatable with respect to the shaft 222. The first member 320 integrally rotates with the gates 200. In the present exemplary embodiment, the gates 200 are provided with the first member 320 via the shaft 222. The first member 320 comes into contact with the second member 340, which will be described later, so that the gates 200 are held at the abutment position.

In addition, the first member 320 is disposed outside a sheet passage area as seen in a plan view. Specifically, as seen in the plan view, the first member 320 is disposed ahead of the gates 200 with respect to the shaft 222. In addition, as seen in a front view, the first member 320 is supported by the shaft 222 at the abutment position in a state of being disposed below the base portions 210 of the gates 200. In addition, the first member 320 is formed such that an end portion on the downstream side in the transportation direction protrudes to be closer to the front side than an end portion on the upstream side is. At the abutment position, the end portion of the first member 320 that is on the downstream side in the transportation direction is disposed upstream of end portions of the gates 200 that are on the downstream side in the transportation direction.

The second member 340 is a thin plate extending in the transportation direction. The second member 340 is supported by the housing 10a. An end portion of the second member 340 that is on the downstream side in the transportation direction is disposed upstream of the second transportation rolls 92 in the transportation direction. At the abutment position, the second member 340 functions as a rotation stopper of the gates 200 by supporting, from below, the end portion of the first member 320 that is on the downstream side in the transportation direction. That is, at the abutment position, the second member 340 restricts the gates 200 from rotating to the withdrawal position side. At the withdrawal position, the second member 340 is disposed in the housing 10a so as not to be in contact with the first member 320. In other words, regarding the first member 320 and the second member 340, the respective lengths thereof in the transportation direction and disposition with respect to the housing 10a are set in accordance with abutment and withdrawal of the gates 200.

As shown in FIGS. 16A and 16B, in a case where the shaft 222 moving integrally with the gates 200 in the forward movement direction passes through the position D3, the first member 320 stops being supported by the second member 340 and a switch from the abutment position to the withdrawal position occurs. A position at which the first member 320 passes through the end portion of the second member 340 that is on the downstream side in the transportation direction is an example of a first position.

Accordingly, regarding the fall prevention member 300, the first member 320 is in contact with the second member 340 so that the gates 200 are held at the abutment position until the gates 200 pass through the predetermined position.

### Action and Effect of Fourth Exemplary Embodiment

The action and effect of the fourth exemplary embodiment will be described.

In the transportation device according to the present exemplary embodiment, the gates 200 are configured to switch to the withdrawal position as the carriage 120 moves to the downstream side and in a case where the recording medium P is jammed on the transportation path 82, the fall prevention member 300 causes the gates 200 to switch to the withdrawal position with the carriage 120 driven such that the gates 200 move to the downstream side beyond a position which is an example of the first position and at which the first member 320 passes through an end portion of the second member 340 that is on the downstream side in the transportation direction.

According to such a configuration, the gates 200 may be held at the withdrawal position without use of a motor directly driving the gates 200 in a case where the recording medium P is jammed on the transportation path 82.

### Fifth Exemplary Embodiment

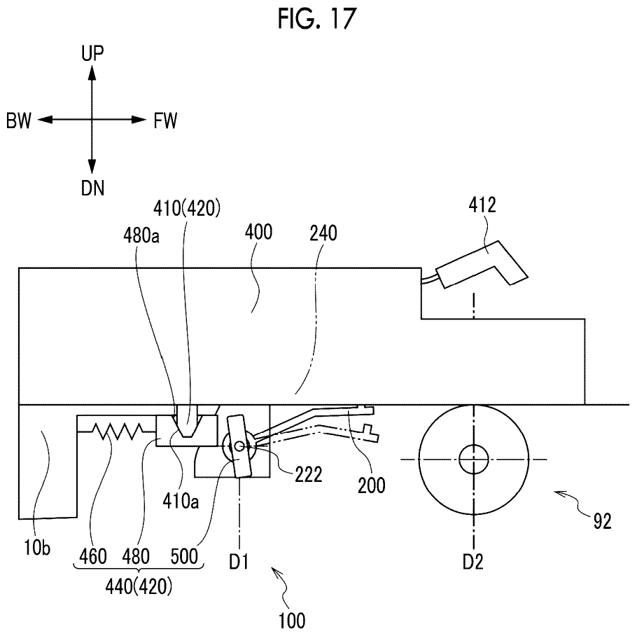

Next, a fifth exemplary embodiment will be described with reference to FIGS. 17 to 19. A transportation device according to the fifth exemplary embodiment is different from the major part of the first exemplary embodiment in that a configuration in which a switch between abutment and withdrawal of the gates 200 is synchronized with another portion in a case where the recording medium P is jammed. Specifically, in the transportation device according to the present exemplary embodiment, the correction mechanism 100 includes a cover 400, a switching unit 420, and a motor (not shown).

### Cover

As shown in FIG. 17, the cover 400 extends in the reciprocating direction of the carriage 120 and the front-rear direction and is disposed above the correction mechanism 100 and the second transportation rolls 92. The cover 400 is rotatably supported by the housing 10a and is openable and closable.

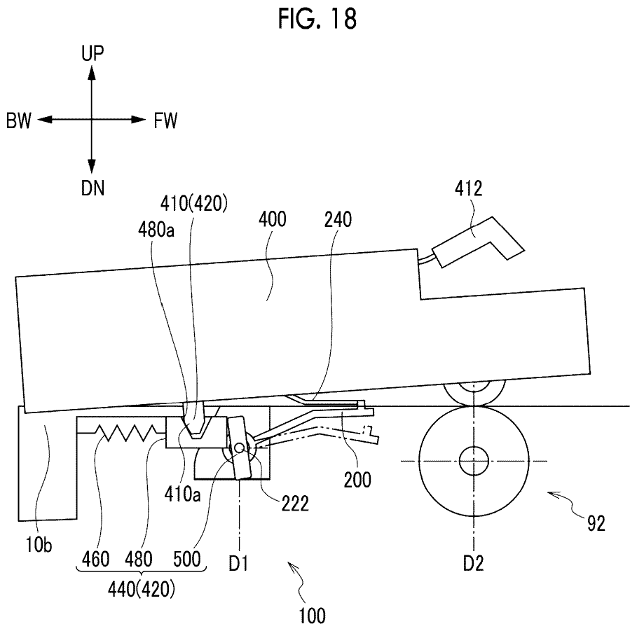

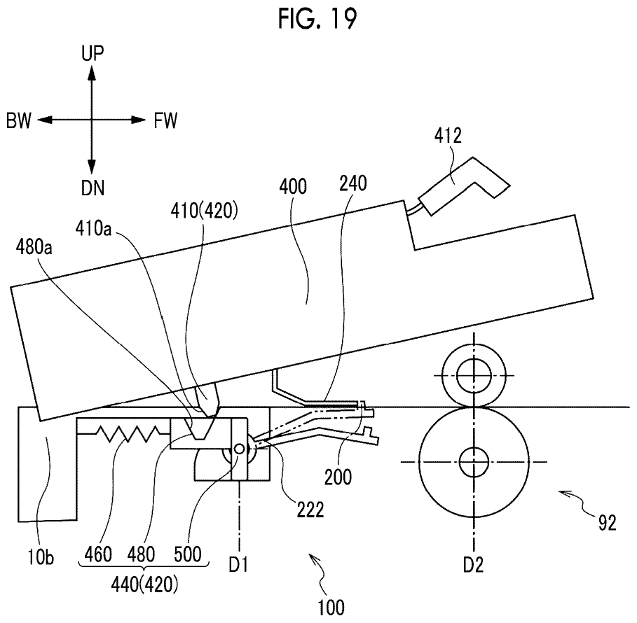

In a closed state, the cover 400 covers the chute 240. In addition, the cover 400 enters an opened state as a lever 412 is pulled. As shown in FIGS. 18 and 19, in a case where the cover 400 is in the opened state, the chute 240 is exposed. Regarding the cover 400, the state of exposure of the chute 240 can be consecutively changed.

### Switching Unit

The switching unit 420 causes the gates 200 to switch from the abutment position to the withdrawal position. Specifically, in a case where the recording medium P is jammed, the switching unit 420 causes the gates 200 to switch from the abutment position to the withdrawal position in synchronization with an operation of opening the cover 400. As shown in FIG. 17, the switching unit 420 includes a projection 410 and a synchronization mechanism 440.

The projection 410 protrudes downward from the cover 400 in a state of extending in the front-rear direction outside the sheet passage area. The projection 410 is attached to the cover 400. Specifically, the projection 410 is attached to the cover 400 on a base portion side. A tip end portion 410a of the projection 410, which is on a side opposite to a base portion, is formed in a tapered shape as seen in a front view. The projection 410 moves as the cover 400 rotates. The projection 410 starts synchronization of the synchronization mechanism 440, which will be described later. The length of the projection 410 in the vertical direction is set such that the tip end portion 410a is positioned between the shaft 222 and the gates 200 in the case of the closed state.

The synchronization mechanism 440 is a mechanism that synchronizes movement in the reciprocating direction with movement in the vertical direction. The synchronization mechanism 440 is disposed below the cover 400 and is disposed outside the sheet passage area. The synchronization mechanism 440 is supported by the housing 10a via a bracket 10b. The synchronization mechanism 440 includes a spring 460, a contact portion 480, and a switching plate 500.

The spring 460 is a compression spring that is disposed upstream of the shaft 222 in the transportation direction and that is elastically deformed in the reciprocating direction. The spring 460 is supported by the bracket 10b. The spring 460 urges the contact portion 480, which will be described later, in the forward movement direction. The spring 460 is compressed most when the cover 400 is in the closed state.

The contact portion 480 is formed in a block-like shape in which a trapezoidal groove 480a is formed in the front-rear direction as seen in a front view. One end of the contact portion 480 that is on the upstream side in the transportation direction is urged by the spring 460. The contact portion 480 moves as the spring 460 is elastically deformed in the reciprocating direction. The contact portion 480 is able to come into contact with the switching plate 500 which will be described later. Specifically, the contact portion 480 comes into contact with the switching plate 500 in a case where the cover 400 is in a predetermined opened state.

In addition, regarding the contact portion 480, the projection 410 is fitted into the groove 480a in a case where the cover 400 enters the closed state. In other words, the groove 480a is formed such that the projection 410 is fitted into the groove 480a. Regarding the contact portion 480, when the state of the cover 400 changes from the closed state to the opened state, the projection 410 moves along the groove 480a with a change in state of the spring 460 urging the contact portion 480.

The switching plate 500 extends in the vertical direction and rotates integrally with the gates 200. In the present exemplary embodiment, the switching plate 500 is attached to the front end portion of the shaft 222 and rotates integrally with the gates 200 via the shaft 222. The switching plate 500 rotates around the central axis of the shaft 222 such that the gates 200 switch from the abutment position to the withdrawal position.

Regarding the switching plate 500, as shown in FIG. 18, in a case where the state of the cover 400 changes from the closed state to the opened state, the contact portion 480 comes into contact with the switching plate 500. As shown in FIG. 19, in a case where the opened state of the cover 400 becomes a predetermined state, the switching plate 500 is rotated clockwise by the contact portion 480. With a change in open state, the switching plate 500 causes the gates 200 to switch from the abutment position to the withdrawal position.

As described above, the switching unit 420 is configured.

### Motor

A motor (not shown) of the correction mechanism 100 according to the present exemplary embodiment moves the gates 200 from the abutment position to the withdrawal position and holds the gates 200 at the withdrawal position. Specifically, in a case where the motor enters the excitation state by being energized by the controller 70, the motor moves the gates 200 from the abutment position to the withdrawal position via the shaft 222 and holds the gates 200 at the withdrawal position.

In addition, the motor enters the demagnetization state in a case where energization performed by the controller 70 is stopped. In addition, in a case where an operation of opening the cover 400 is performed and thus the cover 400 enters the opened state, the motor is forcibly caused to enter the demagnetization state.

As described above, the correction mechanism 100 of the present exemplary embodiment is configured.

### Action and Effect of Fifth Exemplary Embodiment

The action and effect of the fifth exemplary embodiment will be described.

The transportation device according to the present exemplary embodiment further includes the cover 400 that is configured to be openable and closable, that exposes the chute 240 in a case where the cover 400 is in an opened state, and that covers the chute 240 in a case where the cover 400 is in a closed state, and the switching unit 420 includes the synchronization mechanism 440 that causes the gates 200 to switch to the withdrawal position in synchronization with an operation of opening the cover 400.

According to such a configuration, the gates 200 may be held at the withdrawal position without use of a motor directly driving the gates 200 in a case where the recording medium P is jammed on the transportation path.

In addition, the transportation device according to the present exemplary embodiment further includes the motor that moves the gates 200 to the withdrawal position and holds the gate 200 at the withdrawal position in an excitation state and the motor is forcibly caused to enter the demagnetization state in a state where an operation of opening the cover 400 is performed.

According to such a configuration, the gates 200 may be held at the withdrawal position in a case where the recording medium P is jammed on the transportation path even in the case of the demagnetization state of the motor which holds the gates 200 at the withdrawal position.

MODIFICATION EXAMPLES

Hereinabove, a plurality of exemplary embodiments of the present disclosure have been described with reference to the drawings. However, the present disclosure is not limited to the exemplary embodiments and it is clear to those skilled in the art that various other exemplary embodiments of the present disclosure can be adopted within the scope of the present disclosure.

In the third exemplary embodiment, the gates 200 are provided with the first member 320 via the shaft 222. However, the present disclosure is not limited thereto. For example, the first member 320 may be integrally formed with the gates 200.

In the fourth exemplary embodiment, the correction mechanism 100 includes the fall prevention member 300. However, the present disclosure is not limited thereto. The gates 200 may be moved to the withdrawal position after the correction mechanism 100 is moved to the downstream side in the transportation direction in a case where the recording medium P is jammed and there is a reason that the gates 200 cannot be moved to the withdrawal position like a member disposed below the gates 200 or the like.

An example of the image forming apparatus 10 is not limited to the above-described electrophotographic image forming apparatus 10, and for example, various image forming apparatuses including an ink jet image forming apparatus can be used. In an ink jet type image forming apparatus, for example, ink droplets are jetted to a recording medium from a jetting unit (not shown) so that an image is formed on the recording medium.

In the above-described exemplary embodiments, the urging member that urges the abutting member to the abutment position and the motor that moves the abutting member to the withdrawal position and holds the abutting member at the withdrawal position in an excitation state are further provided and the switching unit includes the holding portion that mechanically holds, at the withdrawal position, the abutting member moved to the withdrawal position due to excitation of the motor. However, the present disclosure is not limited thereto. For example, the switching unit may hold the abutment member at the withdrawal position by means of a pair of magnets that repel each other.

In the above-described exemplary embodiments, the holding portion is configured as a stopper that comes into contact with the abutting member positioned at the withdrawal position in a state where the abutting member is moved beyond the movement limit of the reciprocating mechanism for the case of normal operation. However, the present disclosure is not limited thereto. For example, the holding portion may be disposed in a reciprocating movement area for the case of normal operation.

In the above-described exemplary embodiments, the holding portion is configured as the engagement portion that is engaged with the abutting member in a state where the abutting member is moved to the withdrawal position side beyond the movement limit for the case of normal operation. However, the present disclosure is not limited thereto. For example, the holding portion may be disposed in a withdrawal-position-side movement area for the case of normal operation.

In the above-described exemplary embodiments, the abutting member is configured to switch to the withdrawal position as the reciprocating mechanism moves to the downstream side and in a case where the medium is jammed on the transportation path, the switching unit causes the abutting member to switch to the withdrawal position with the reciprocating mechanism driven such that the abutting member moves to the downstream side beyond the first position. However, the present disclosure is not limited thereto. For example, in a case where the medium is jammed on the transportation path, the switching unit may cause the abutment member to switch to the withdrawal position in a state where the reciprocating mechanism is driven such that the abutting member is moved to a position that is closer to the upstream side in the transportation direction than the first position is.

In the above-described exemplary embodiments, a covering portion that is configured to be openable and closable, that exposes the restricting member in a case where the covering portion is in an opened state, and that covers the restricting member in a case where the covering portion is in a closed state is further provided and the switching unit includes a synchronization mechanism that causes the abutting member to switch to the withdrawal position in synchronization with an operation of opening the covering portion. However, the present disclosure is not limited thereto. For example, the switching unit may cause the abutment member to switch to the withdrawal position regardless of the operation of opening the covering portion.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content. Further, the program in the present disclosure may be provided as a program product.

### SUPPLEMENTARY NOTES

(((1))) A transportation device comprising:
a transportation member that transports a medium in a transportation direction;
a reciprocating mechanism that reciprocates in the transportation direction and that moves at a speed lower than a transportation speed of the medium transported by the transportation member in a case where the reciprocating mechanism moves to a downstream side;
an abutting member that is supported by the reciprocating mechanism and that switches between an abutment position at which the medium abuts against the abutting member on a transportation path of the medium and a withdrawal position to which the abutting member withdraws from the transportation path after the abutting member passes through a predetermined first position;
a restricting member that restricts the medium, of which a leading end abuts against the abutting member, from being separated from the transportation path; and
a switching unit that causes the abutting member to switch to the withdrawal position in a case where the medium is jammed on the transportation path.

(((2))) The transportation device according to (((1))), further comprising:
an urging member that urges the abutting member to the abutment position; and
a motor that moves the abutting member to the withdrawal position and holds the abutting member at the withdrawal position in an excitation state,
wherein the switching unit includes a holding portion that mechanically holds, at the withdrawal position, the abutting member moved to the withdrawal position due to excitation of the motor.

(((3))) The transportation device according to (((2))),
wherein the holding portion is configured as a stopper that comes into contact with the abutting member positioned at the withdrawal position in a state where the abutting member is moved beyond a movement limit of the reciprocating mechanism for a case of normal operation.

(((4))) The transportation device according to (((2))) or (((3))),
wherein the holding portion is configured as an engagement portion that is engaged with the abutting member in a state where the abutting member is moved to a withdrawal position side beyond a movement limit for a case of normal operation.

(((5))) The transportation device according to any one of (((1))) to (((4))),
wherein the abutting member is configured to switch to the withdrawal position as the reciprocating mechanism moves to the downstream side, and
in a case where the medium is jammed on the transportation path, the switching unit causes the abutting member to switch to the withdrawal position with the reciprocating mechanism driven such that the abutting member moves to the downstream side beyond the first position.

(((6))) The transportation device according to any one of (((1))) to (((5))), further comprising:
a covering portion that is configured to be openable and closable, that exposes the restricting member in a case where the covering portion is in an opened state, and that covers the restricting member in a case where the covering portion is in a closed state,
wherein the switching unit includes a synchronization mechanism that causes the abutting member to switch to the withdrawal position in synchronization with an operation of opening the covering portion.

(((7))) The transportation device according to (((6))), further comprising:
a motor that moves the abutting member to the withdrawal position and holds the abutting member at the withdrawal position in an excitation state,
wherein the motor is forcibly caused to enter a demagnetization state in a state where the operation of opening the covering portion is performed.

(((8))) An image forming apparatus comprising:
the transportation device according to any one of (((1))) to (((7))); and
a forming unit that forms an image on the medium transported by the transportation device.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A transportation device comprising:
a transportation member that transports a medium in a transportation direction;
a reciprocating mechanism that reciprocates in the transportation direction and that moves at a speed lower than a transportation speed of the medium transported by the transportation member in a case where the reciprocating mechanism moves to a downstream side;
an abutting member that is supported by the reciprocating mechanism and that switches between an abutment position at which the medium abuts against the abutting member on a transportation path of the medium and a withdrawal position to which the abutting member withdraws from the transportation path after the abutting member passes through a predetermined first position;
a restricting member that restricts the medium, of which a leading end abuts against the abutting member, from being separated from the transportation path; and
a switching unit that causes the abutting member to switch to the withdrawal position in a case where the medium is jammed on the transportation path.

2. The transportation device according to claim 1, further comprising:
an urging member that urges the abutting member to the abutment position; and
a motor that moves the abutting member to the withdrawal position and holds the abutting member at the withdrawal position in an excitation state,
wherein the switching unit includes a holding portion that mechanically holds, at the withdrawal position, the abutting member moved to the withdrawal position due to excitation of the motor.

3. The transportation device according to claim 2,
wherein the holding portion is configured as a stopper that comes into contact with the abutting member positioned at the withdrawal position in a state where the abutting member is moved beyond a movement limit of the reciprocating mechanism for a case of normal operation.

4. The transportation device according to claim 2,
wherein the holding portion is configured as an engagement portion that is engaged with the abutting member in a state where the abutting member is moved to a withdrawal position side beyond a movement limit for a case of normal operation.

5. The transportation device according to claim 1,
wherein the abutting member is configured to switch to the withdrawal position as the reciprocating mechanism moves to the downstream side, and
in a case where the medium is jammed on the transportation path, the switching unit causes the abutting member to switch to the withdrawal position with the reciprocating mechanism driven such that the abutting member moves to the downstream side beyond the first position.

6. The transportation device according to claim 1, further comprising:
a covering portion that is configured to be openable and closable, that exposes the restricting member in a case where the covering portion is in an opened state, and that covers the restricting member in a case where the covering portion is in a closed state,
wherein the switching unit includes a synchronization mechanism that causes the abutting member to switch to the withdrawal position in synchronization with an operation of opening the covering portion.

7. The transportation device according to claim 6, further comprising:
a motor that moves the abutting member to the withdrawal position and holds the abutting member at the withdrawal position in an excitation state,
wherein the motor is forcibly caused to enter a demagnetization state in a state where the operation of opening the covering portion is performed.

8. An image forming apparatus comprising:
the transportation device according to claim 1; and
a forming unit that forms an image on the medium transported by the transportation device.

9. An image forming apparatus comprising:
the transportation device according to claim 2; and
a forming unit that forms an image on the medium transported by the transportation device.

10. An image forming apparatus comprising:
the transportation device according to claim 3; and
a forming unit that forms an image on the medium transported by the transportation device.

11. An image forming apparatus comprising:
the transportation device according to claim 4; and
a forming unit that forms an image on the medium transported by the transportation device.

12. An image forming apparatus comprising:
the transportation device according to claim 5; and
a forming unit that forms an image on the medium transported by the transportation device.

13. An image forming apparatus comprising:
the transportation device according to claim 6; and
a forming unit that forms an image on the medium transported by the transportation device.

14. An image forming apparatus comprising:
the transportation device according to claim 7; and
a forming unit that forms an image on the medium transported by the transportation device.
